(19) United States
(12) Patent Application Publication
(10) Pub. No.: US 2013/0192923 A1
(43) Pub. Date: Aug. 1, 2013

(54) Safety harness with descender attachment AKA: Down E-Z

(71) Applicant: Mickey McArthur Kennedy, Medina, OH (US)

(72) Inventor: Mickey McArthur Kennedy, Medina, OH (US)

(21) Appl. No.: 13/385,023

(22) Filed: Jan. 30, 2012

(51) Int. Cl. A62B 35/00

(52) U.S. Cl. 182/5; 182/3

(57) ABSTRACT

The disclosed subject matter relates to an apparatus so designed that when properly used may aid in the prevention of injury and or even death. This device is so designed that a fallen hunter is left hanging facing the tree, allowing mobility and movement. With the attached (DOWN E-Z) device, one may lower himself to the ground with little or no effort. This final step is very important due to the documented factual records of hunters dying while being left hanging for hours and blood begins to clot.

### TECHNICAL FIELD

This present application relates to a safety harness used mostly by tree stand Hunters with a Descender attachment for self controlled lowering ones self to the ground in case of an accidental fall.

### BACKGROUND

Due to the awareness of bodily injury and even death, more hunters are turning to a safety device of which can prevent injury and even save a life.

There are several body harnesses on the market of which few have an attached device for lowering ones self to safety. With this harness design, if one falls from his or her stand, the hunter will be facing the tree instead of dangling on the end of a harness with back to the tree. Now comes the attached descending device.

The descending device is so designed so as to allow the fallen hunter to descend the tree by merely moving locking prussic knot in a downward motion and in turn allowing the invented device to move downward until hunter reaches the ground.

### BRIEF DESCRIPTION OF DRAWINGS

FIG. 1-A is a depiction of the prussic knot in association with the donut release mechanism for providing a brake to the belay device, a mainstay to this patent application. This device is used to control the descent to lower level.

FIG. 1-B the safety hook, a purchased device, for attaching the rope to the belay device and capable of locking to prevent accidental release.

FIG. 1-C the quick hook also purchased, having a spring loaded closure and used in connecting the prussic rope to the leg harness.

FIG. 1-D, the carabiner purchased item, used to attach the Down E-Z system to the harness on the front loops of harness, having locking capabilities.

FIG. 2-A is the mainstay of this patent application, used to control the descent to a lower level in conjunction with the Prussic knot. This belay device having 3 holes drilled in a triangular configuration uses friction to control the speed of descent. There is a fourth hole for those weighing in excess of 200 lbs.

Pg. 3-7 is a detail of FIG. 1-A the Prussic knot and Donut brake release. Used to stop the fall if accidental fall occurs. This configuration and use of the prussic knot with donut is privy to this patent application.

FIG. 4-A, the storage bag, so designed to contain within, all the necessary parts for Down E-Z, controlled descent system.

FIG. 5-A, being a rear view of the harness associated with the DOWN E-Z System, with noted diagonal attachment of leg harness parts to the vertically designed support straps.

FIG. 6-A , is the side view of the lag harness and front and rear support straps.

FIG. 7-A is a detail of the front harness belt and adjustable straps. Also shown is the diagonally attached leg strap to the vertical supporting strap giving vertical support to the DOWN E-Z System.

### DETAILED DESCRIPTIONS

THESE DESCRIPTIONS PERTAIN TO THE PATENT APPLICATION AND PARTS THEREOF PERTAINING TO INVENTED USE AND OR NEW DESIGNS OF PARTS. DOES NOT APPLY TO PURCHASED PARTS BY OTHER DESIGNE.

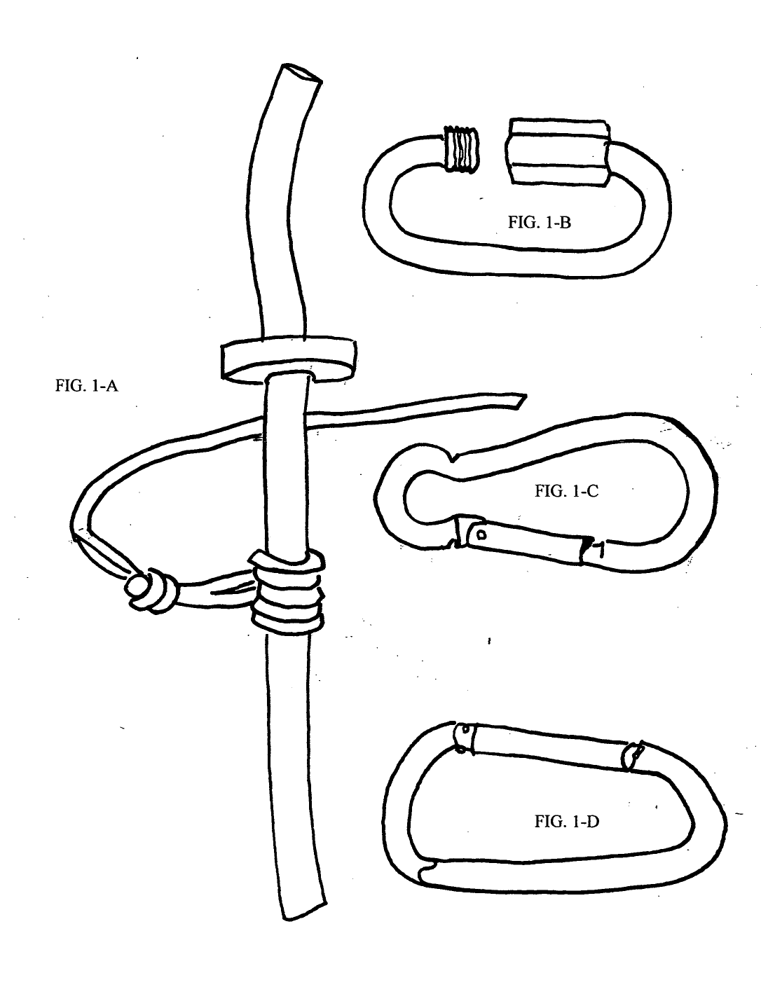

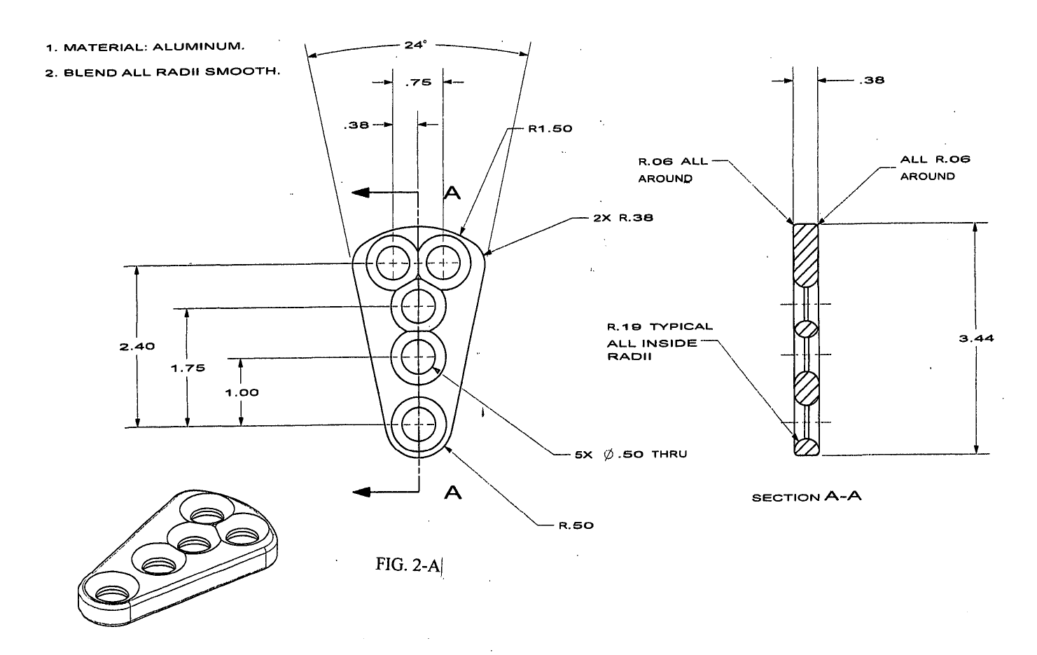

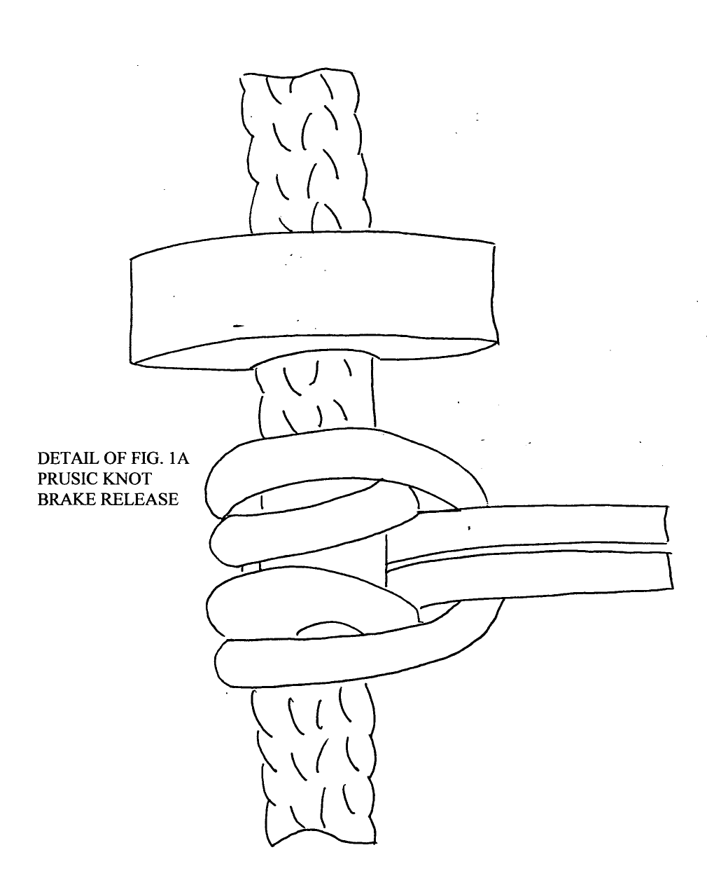

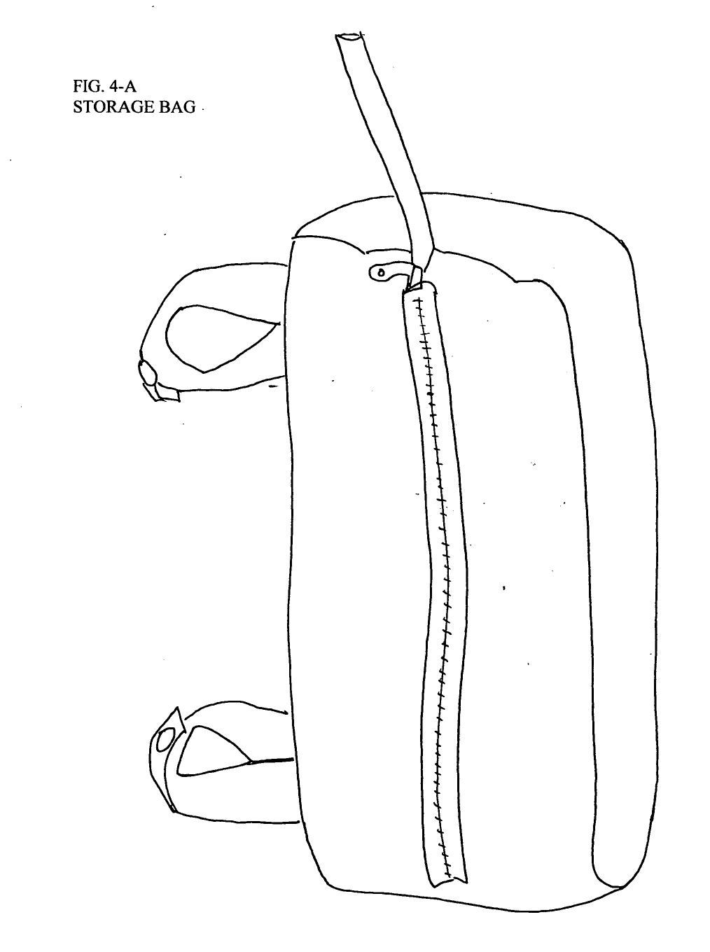

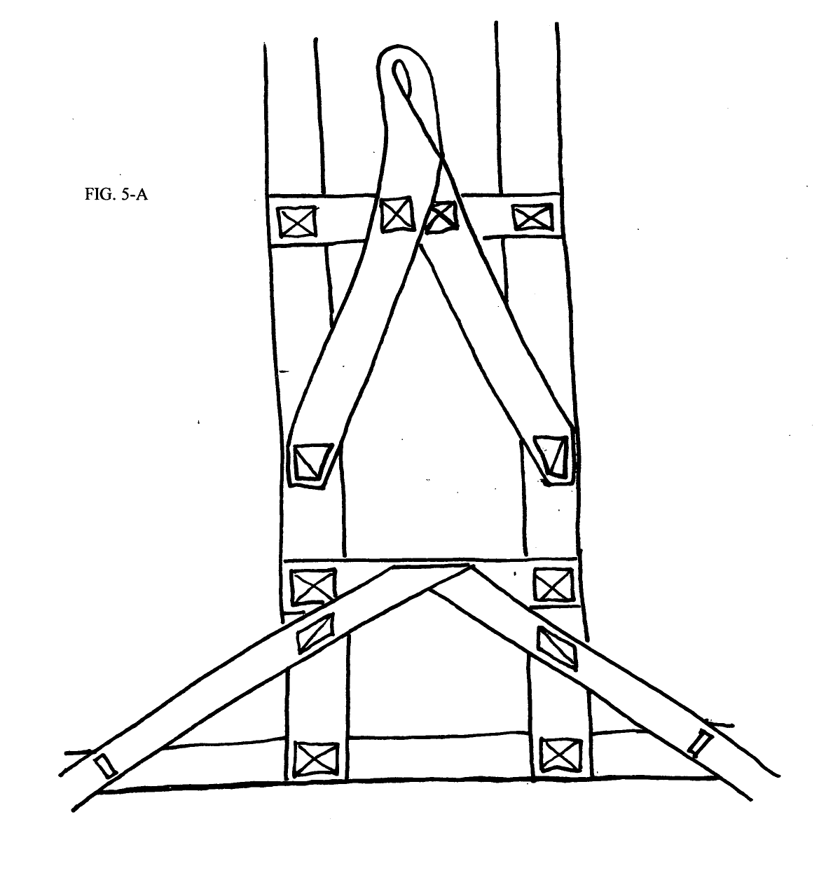

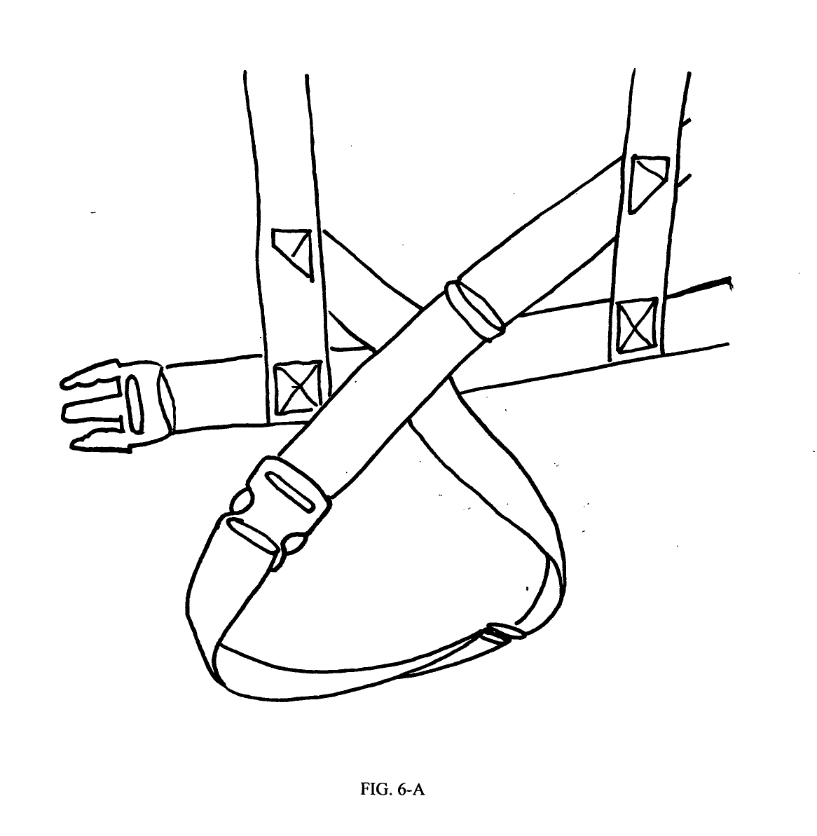

Pg. 1-7 FIG. 1-A, the Prussic Knot being a 5 mm rope with enclosed loop and wrapped around the belay rope in such a manner that it will hold pressure in a downward motion when attached to the leg harness via carabiner device.

Pg. 1-7 FIG. 1-B, (purchased) safety hook. Used for attaching the belay device to the tree harness and having a screw locking mechanism to prevent accidental release.

Pg. 1/7 FIG. 1-C (purchased) safety hook with swing locking mechanism. This device can be used for attaching the Prussic device to the leg harness.

Pg. 1, FIG. 1-D (purchased) carabiner, used in conjunction with the Down E-Z for attaching to the 2 frontal hook-up loops unique to this system.

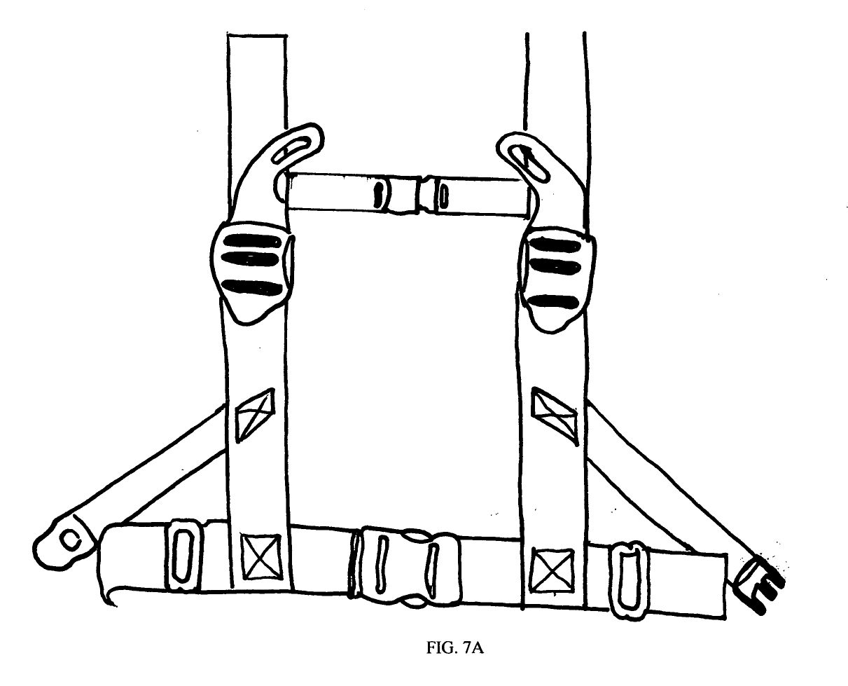

Pg. 7-7, FIG. 7-A is a frontal view of the harness with fontal hook up loops for frontal descent downward from an elevated positing. Also shown in the view is the diagonal leg harness in association to the waist belt.

What is claimed:

1) An apparatus so designed for tree stand hunters that will allow said hunters to face the tree and lower ones self to the ground.

2) The apparatus in claim 1, whereas the leg straps are maintained in a vertical support direction with leg encirclement therefore preventing direct pressure to the femoral arteries.

3) The apparatus in claim 1, whereas the retention straps, front and rear, have a vertical support structure parallel to the spine and therefore transfers the support thru the belt into the leg harnesses supporting the body thru the encirclement of the legs.

4) The apparatus in claim 1, whereas the frontal support hooks are located in proximity of the horizontal center of chest allowing one to hang facing the tree.

5) The apparatus in claim 1, whereas the rear support hook, located in top center of back, may be used if so desired or if another harness is used and one desires to utilize the DOWN E-Z device for descending the tree.

6) The apparatus in claim 1, whereas the belaying device (DOWN E-Z) is utilized to descend the rope in a safe manner by merely applying pressure to the loose end of rope to control speed of the descent to the ground.

7) The apparatus in claim 1, whereas the harness belt is utilized in such a manner that the support structure does not depend on the belt for supporting the hunter or climber. Secondary devices may be attached to the belt.

8) The apparatus in claim 1, whereas a secondary rope is utilized for the climber to descend the tree. The rope when used in conjunction with the belay device will control ones descent in a safe manner.

9) The apparatus in claim 1, whereas the chest straps may be used as a support sling when facing the tree and stability of weapon is desired.

10) The apparatus in claim 1, whereas the DOWN E-Z portion of tree harness is so designed that the configuration of holes in belay device is not confined to a triangular application. May be positioned and sized to accommodate the different weights of the intended climber. The belay device merely provides friction to control the descent downward.

11) The apparatus in claim 1, whereas no matter what your outdoor desires may be, where fall protection is needed, this safety harness and belay device will give comfort and safety to the user.
